(19) United States
(12) Patent Application Publication
(10) Pub. No.: US 2017/0068480 A1
(43) Pub. Date: Mar. 9, 2017

(54) Power Saving Methodology for Storage Device Equipped with Task Queues

(71) Applicant: MEDIATEK INC., Hsinchu (TW)

(72) Inventor: Shen-Wen Huang, Hsinchu City (TW)

(21) Appl. No.: 15/176,312

(22) Filed: Jun. 8, 2016

Related U.S. Application Data
(60) Provisional application No. 62/215,857, filed on Sep. 9, 2015.

(51) Int. Cl. G06F 3/06; G06F 13/364; G06F 13/42; G06F 1/32

(52) U.S. Cl. CPC G06F 3/0625; G06F 1/3287; G06F 3/0659; G06F 3/0688; G06F 13/364; G06F 13/4291

(57) ABSTRACT

A method of power saving for storage device with device queue management is proposed. A host controller is allowed to send commands or signals to a storage device, which will be notified to go to a low power stare or SLEEP mode, even when there are pending tasks left in a device queue waiting for execution. Similarly, the storage device is allowed to keep pending tasks before go to sleep and then restore the pending tasks by pushing the pending tasks back into the device queue again after waking up. Alternatively, the storage device notifies the host controller the number of pending tasks left in the device queue before go to sleep. The storage device can simply be awaken with an empty queue and the host controller will restart task queueing for the number of notified pending tasks again.

### CROSS REFERENCE TO RELATED APPLICATIONS

This application claims priority under 35 U.S.C. §119 from U.S. Provisional Application No. 62/215,857 entitled, “Power Saving Methodology for Storage Device Equipped with Task Queues” filed on Sep. 9, 2015; the subject matter of which is incorporated herein by reference.

### TECHNICAL FIELD

The disclosed embodiments relate generally to controlling of storage devices, and, more particularly, to methodology for host to put storage device into low power state to save more power.

### BACKGROUND

A data storage device is a device for recording and storing data information. Recording can be done by using virtually any form of energy, spanning from manual muscle power in handwriting, to acoustic vibrations in phonographic recording, to electromagnetic energy modulating magnetic tape and optical discs. Electronic data storage requires electrical power to store and retrieve that data. Most electronically processed data storage media (including some forms of computer data storage) are considered permanent (non-volatile) storage, that is, the data will remain stored when the device power off. In contrast, most electronically stored information within most types of semiconductor (computer chips) microcircuits are volatile memory, for it vanishes if power is removed. Flash memory is an electronic non-volatile computer storage medium that can be electrically erased and reprogrammed. There are two main types of flash memory, which are named after the NAND and NOR logic gates. A solid-state drive (SSD) is a solid-state storage device that uses integrated circuit assembles as memory to store data persistently. Most SSDs use NAND-based flash memory. A MultiMediaCard (MMC) is a memory card standard used for solid-state storage.

Modern storage devices, such as eMMC (embedded MMC) and UFS (Universal Flash Storage), are equipped with device queues that allows the storage device to queue more than one data transfer requests from its host device. Once data transferring between host device and storage device via data bus, the storage device tends to prepare data for queued tasks or receive new requests from the host device simultaneously. However, since it is not allowed to put such storage device into low power state or SLEEP mode unless there is no pending task left in the device queue, the storage device will consume more power when device queues are being used. For example, when the host device plans to order the storage device to sleep, the host device will first check whether the device queue is empty or not. The host device can order the storage device to sleep only if the device queue is empty. As a result, it may take much longer for the storage device to sleep when there are pending tasks in the device queue.

A solution is sought to put storage device into low power state or sleep mode efficiently for more power saving of the storage device.

### SUMMARY

A method of power saving for storage device with device queue management is proposed. A host controller is allowed to send commands or signals to a storage device, which will be notified to go to a low power stare or SLEEP mode, even when there are pending tasks left in a device queue waiting for execution. Similarly, the storage device is allowed to keep pending tasks before go to sleep and then restore the pending tasks by pushing the pending tasks back into the device queue again after waking up. Alternatively, the storage device notifies the host controller the number of pending tasks left in the device queue before go to sleep. The storage device can simply be awaken with an empty queue and the host controller will restart task queueing for the number of notified pending tasks again.

A storage device accepts a plurality of task requests from a host controller. Each task request is pushed into a task queue of the storage device for later execution. The storage device receives a power-saving command from the host controller for the storage device to enter a power-saving mode while there are pending queued tasks remained in the task queue of the storage device. The storage device processes pending queued tasks to satisfy a power-saving condition. The storage device enters the power-saving mode upon satisfying the power-saving condition before completing the pending queued tasks. In one embodiment, the power-saving condition is satisfied when the storage device stores the pending queued tasks into a non-volatile memory. In another embodiment, the power-saving condition is satisfied when the storage device notifies the host controller to reschedule the pending queued tasks after waking up from the power-saving mode. For example, each pending queued task can be notified via corresponding task information comprising a task identification (ID), a task size, an address associated with task data, and a task status.

A host controller sends a plurality of task requests to a storage device. Each task request is pushed into a task queue of the storage device for later execution. The host controller transmits a power-saving command to the storage device for the storage device to enter a power saving mode while there are pending queued tasks remained in the task queue of the storage device. The host controller receives task information for the pending queued tasks from the storage device. For example, each pending queued task can be notified via corresponding task information comprising a task ID, a task size, an address associated with task data, and a task status. The host controller reschedules the pending queued tasks after waking up the storage device.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a storage network having a host device and a modern storage device with device queues in accordance with embodiments of the current invention for more power saving.

FIG. 2 illustrates an exemplary block diagram of a host device and a storage device in accordance with embodiments of the current invention.

FIG. 3A illustrates an exemplary diagram of task queue and data transfer for device queue management in modern storage devices.

FIG. 3B illustrates another exemplary diagram of task queue and data transfer for device queue management in modern storage devices.

FIG. 3C illustrates another exemplary diagram of task queue and data transfer for device queue management in modern storage devices.

FIG. 4 illustrates a first embodiment for host to put storage device into low power state or sleep mode for more power saving for storage device with device queue management.

FIG. 5 illustrates a second embodiment for host to put storage device into low power state or sleep mode for more power saving for storage device with device queue management.

FIG. 6 is a flow chart of a method of power saving, from storage device perspective, for storage device with device queue management in accordance with embodiments of the current invention.

FIG. 7 is a flow chart of a method of power saving, from host device perspective, for storage device with device queue management in accordance with embodiments of the current invention.

### DETAILED DESCRIPTION

Reference will now be made in detail to some embodiments of the invention, examples of which are illustrated in the accompanying drawings.

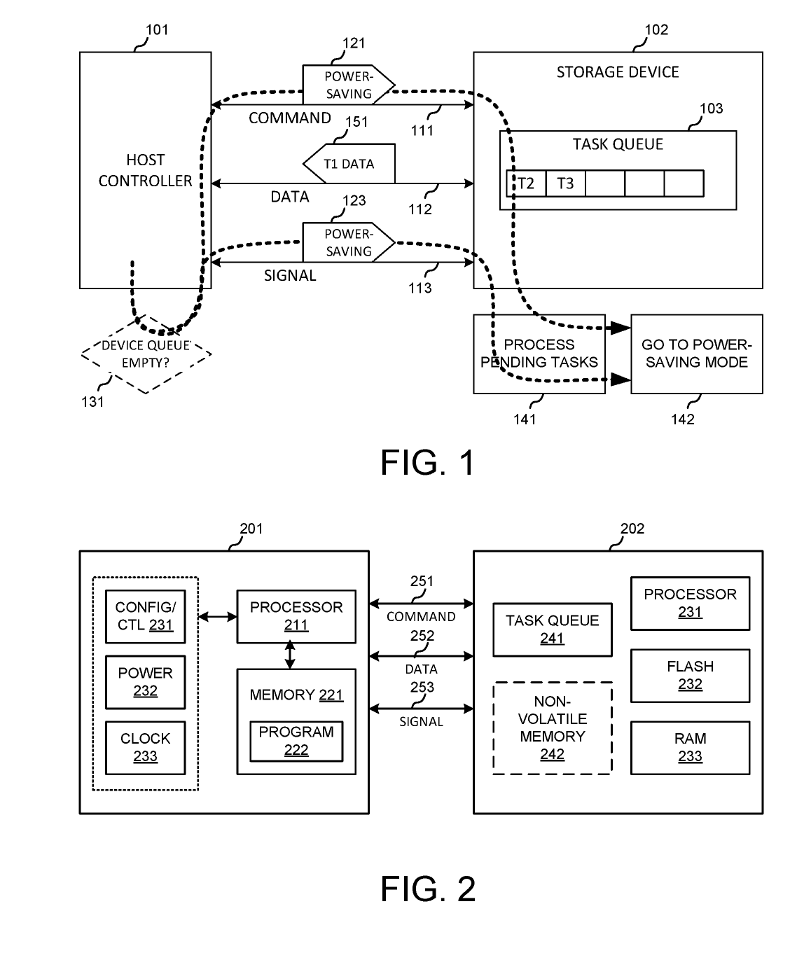

FIG. 1 illustrates a storage network having a host controller 101 and a modern storage device 102 with device queues in accordance with embodiments of the current invention for more power saving. Host controller 101 and storage device 102 communicate with each other via bi-directional command bus 111, data bus 112, and signal bus 113. Storage device 102 is equipped with one or more task queue(s) 103 that allows the device to queue more than one task requests from the host controller. In one example, storage device 102 is a modern mobile storage device, such as eMMC (embedded MMC) and UFS (Universal Flash Storage). Each task request is typically associated with data transfer between the host controller and the storage device. Once data transfer between the host controller and the storage device via data bus 112, device 102 can prepare data for queued tasks or receive new task requests via command bus 111 simultaneously. To save power consumption, the host controller can order the storage device to enter low power state or SLEEP mode. The low power state or the SLEEP mode are sometimes also referred to as a power-saving mode.

Currently, it is not allowed to put the storage device into low power state or SLEEP mode unless there is no pending task left in the device queue. As a result, the storage device will consume more power when device queues are being used. For example, when host controller 101 plans to order storage device 102 to sleep, the host controller will first check whether task queue 103 is empty or not. The host controller can order the storage device to sleep only if the task queue is empty. Therefore, it may take much longer for the storage device to go to low power state or SLEEP mode when there are pending tasks in task queue 103.

In accordance with one novel aspect, host controller 101 is allowed to send commands or signals to storage device 102, which will be notified to go to a low power state or SLEEP mode, even when there are pending tasks left in task queue 103 waiting for execution. Similarly, storage device 102 is allowed to keep pending tasks before go to sleep and then restore the pending tasks by pushing the pending tasks back into the task queue 103 again after waking up. Alternatively, storage device 102 notifies host controller 101 the number of pending tasks left in the task queue 103 before go to sleep. Storage device 102 can simply be awaken with an empty queue and host controller 101 will restart task queueing for the number of notified pending tasks again.

In the example of FIG. 1, host controller 101 sends a plurality of task requests (for tasks T1, T2, T3 . . . ) to storage device 102 via command bus 111. The tasks are pushed into task queue 103 for later execution. For example, task T1 is ready and then executed, storage device 102 starts to transfer T1 data 151 to host controller 101 via data bus 112. Task T1 is then popped out of task queue 103, while tasks T2 and T3 are still pending in task queue 103 waiting to be executed. In accordance with one novel aspect, when the host controller 101 plans the storage device to go to power-saving mode, it directly sends a power-saving command 121 via the command bus 111, or directly sends a power-saving signal 123 via the signal bus 113. The host controller 101 sends such command or signal without first determining whether the task queue 103 is empty or not (e.g., step 131 is omitted). In other words, when the host controller 101 sends the power-saving command or signal, there may still be pending queued tasks (e.g., T2 and T3) remained in task queue 103 of the storage device 102. Upon receiving the power-saving command or signal, the storage device 102 processes the pending tasks in step 141 and then goes to power-saving mode in step 142. By putting the storage device into power-saving mode, more power can be saved because the storage device can go to power-saving mode quickly without having to complete the execution of all pending tasks in the task queue 103.

FIG. 2 illustrates an exemplary block diagram of a host controller 201 and a storage device 202 in accordance with embodiments of the current invention. Host controller 201 comprises a processor 211, memory 221, a configuration and control circuit 231, a power supply circuit 232, and a clocking circuit 233. Processor 211 processes commands, data, and signals and invokes different functional modules to perform features in host controller 201. Memory 221 stores program instructions 222 and data to control the operations of host controller 201. The functional modules are circuits that can be implemented and configured via hardware, firmware, software, and combination thereof. Host controller 201 can store data to storage device 202 or load data from storage device 202 by transferring data on DATA bus 252. Handshaking between host controller 201 and storage device 202 includes at most one COMMAND bus 251 with specific protocol defined. Other necessary wires may include clock, power supply, ground, delay chain, reset, interrupt, etc., which are represented by SIGNAL bus 253. In one example, host controller 201 sends a power-saving command or signal to storage device 202 without determining whether a task queue 241 in the storage device 202 is empty or not to achieve more power saving.

Storage device 202 comprises a processor 231, flash memory 232, random access memory (RAM) 233, the task queue 241, and non-volatile memory 242. Non-volatile memory 242 may belong to part of flash memory 232 or may be a separate memory. Processor 231 processes commands, data, and signals and invokes different functional modules to perform features in storage device 202. Flash memory 232 and RAM 233 stores program instructions and data to control the operations of storage device 202. Storage device 202 also includes a set of control modules and circuits that carry out functional tasks. The control modules and circuits can be implemented and configured by hardware, firmware, software, and combination thereof. Storage device 202 consists of a queue mechanism to pre-fetch data for requests from host controller 201.

In one example, task queue 241 is used to queue more than one data transfer requests from the host controller 201. Each task request is typically associated with data transfer between the host controller 201 and the storage device 202. Once data transfer between the host controller 201 and the storage device 202 via data bus 252, storage device 202 can prepare data for queued tasks or receive new task requests via command bus 251 simultaneously. Upon receiving a power-saving command or signal from the host controller 201, storage device 202 is allowed to keep pending tasks before go to sleep upon satisfying a condition. For example, storage device 202 stores the pending tasks to non-volatile memory 242 before going to sleep. After waking up, storage device 202 then restores the pending tasks by pushing the pending tasks back into task queue 241 again from non-volatile memory 242. Alternatively, storage device 202 notifies host controller 201 the number of pending tasks left in the task queue 241 before going to sleep. Storage device 202 can simply be awaken with an empty task queue 241 and host controller 201 will restart task queueing for the number of notified pending tasks again.

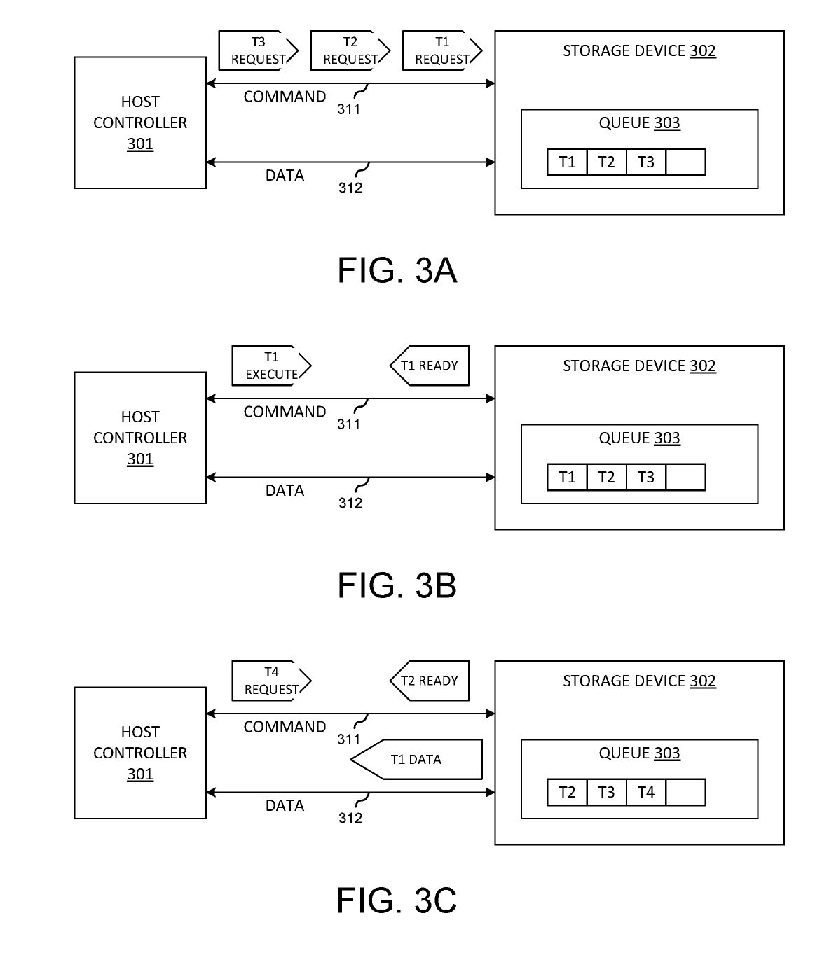

FIG. 3A illustrates an exemplary diagram of task queue and data transfer for device queue management in modern storage devices. In the example of FIG. 3A, host controller 301 and storage device 302 communicates via a command bus 311 and a data bus 312. Host controller 301 sends requests for tasks T1, T2, and T3 to storage device 302 via command bus 311. Storage device 302 then pushes the requests into its device queue 303.

FIG. 3B illustrates another exemplary diagram of task queue and data transfer for device queue management in modern storage devices. In the example of FIG. 3B, host controller 301 and storage device 302 communicates via a command bus 311 and a data bus 312. Continue from FIG. 3A, when task T1 is ready, storage device 302 sends a “T1 Ready” status to host controller 301, which then sends a “T1 Execute” command back to storage device 302 via command bus 311.

FIG. 3C illustrates another exemplary diagram of task queue and data transfer for device queue management in modern storage devices. In the example of FIG. 3C, host controller 301 and storage device 302 communicates via a command bus 311 and a data bus 312. Continue from FIG. 3B, upon receiving the “T1 Execute” command, storage device 302 starts to transfer T1 data to host controller 301 via data bus 312. Storage device 302 then pops task T1 out of device queue 303. During T1 data transferring, host controller 301 requests a new task T4 via command bus 311. Storage device 302 then pushes request T4 into device queue 303. During T1 data transferring, host controller 301 also receives a task status “T2 Ready” for execution via command bus 311.

In traditional power saving mechanism, such as defined in JEDEC: JESD84-B51 for eMMC5.1, JESD220B for UFS2.0, a host controller is not allowed to send commands to order a storage device to go to sleep or enter low power mode until device queue is empty. As a result, when the host controller plans to order the storage device to sleep, it first needs check whether device queue is in use and whether the device queue is empty if used. If the answer is no, then the host controller will not order the storage device to sleep and the storage device continues to do queue operation for the pending queued tasks. If the answer is yes, then the host controller orders the device to sleep or enter low power mode. Therefore, it may take much longer for the storage device to go to sleep or enter low power state when there are pending tasks remained in the device queue. In accordance with one novel aspect, the host controller is allowed to send commands or signals to storage device to sleep or enter low power mode directly to achieve more power saving.

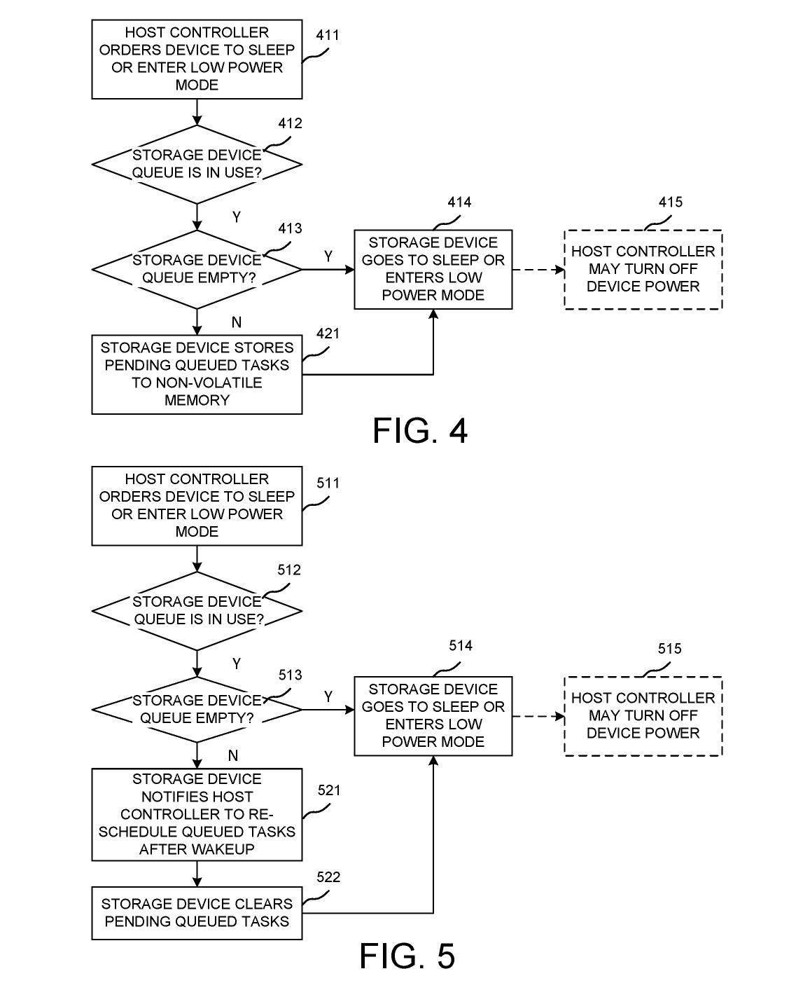

FIG. 4 illustrates a first embodiment for a host controller to put a storage device into low power state or sleep mode for more power saving for storage device with device queue management. In step 411, the host controller orders the storage device to sleep or enter low power mode. In step 412, the host controller checks whether device queue management is in use in the storage device. If the answer is yes, then in step 413, the storage device checks if its device queue is empty. If the answer is yes, then the storage device goes to sleep or enter low power state in step 414. Otherwise, in step 421, the storage device stores the pending queued tasks to a non-volatile memory, which satisfies the condition to go to sleep. The storage device then goes to step 414. Later, when the storage device wakes up, it restores the pending tasks by pushing the pending tasks from the non-volatile memory back into the device queue again. In one example, the supply power of the storage device is provided by the host controller. When the storage device goes to sleep, the host controller can optionally turn off its supply power for more power saving (step 415).

FIG. 5 illustrates a second embodiment for a host controller to put a storage device into low power state or sleep mode for more power saving for storage device with device queue management. In step 511, the host controller orders the storage device to sleep or enter low power mode. In step 512, the host controller checks whether device queue management is in use in the storage device. If the answer is yes, then in step 513, the storage device checks if its device queue is empty. If the answer is yes, then the storage device goes to sleep or enter low power state in step 514. Otherwise, in step 521, the storage device notifies the host controller to re-schedule the pending queued tasks after storage device wakeup. In one example, the storage device sends a list of the pending queued task information to the host controller. The information may comprise a task identification (ID), a task size, a task address for data transfer, and a task status. In step 522, the storage device clears the pending queued tasks from the device queue. After steps 521 and 522, the condition to go to sleep is satisfied. The storage device then goes to step 514. Later, when the storage device wakes up, the host controller restarts task queueing for the list of notified pending tasks again. In one example, the supply power of the storage device is provided by the host controller. When the storage device goes to sleep, the host controller can optionally turn off its supply power for more power saving (step 515).

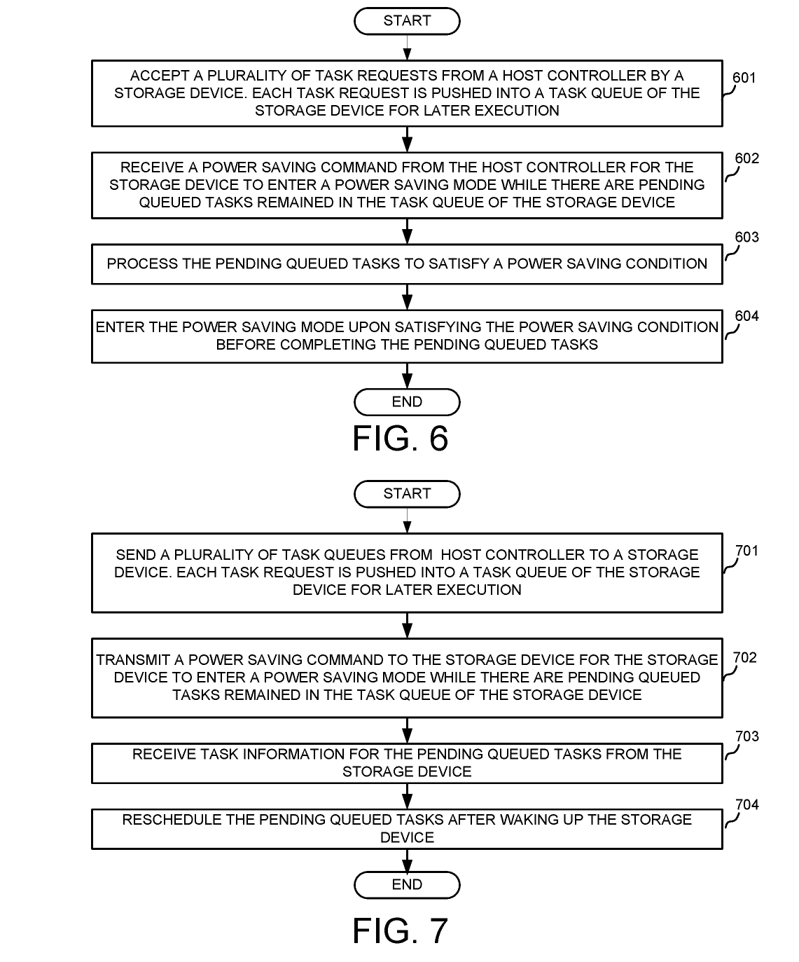

FIG. 6 is a flow chart of a method of power saving, from storage device perspective, for storage device with device queue management in accordance with embodiments of the current invention. In step 601, a storage device accepts a plurality of task requests from a host controller. Each task request is pushed into a task queue of the storage device for later execution. In step 602, the storage device receives a power-saving command from the host controller for the storage device to enter a power-saving mode while there are pending queued tasks remained in the task queue of the storage device. In step 603, the storage device processes pending queued tasks to satisfy a power-saving condition. In step 604, the storage device enters the power-saving mode upon satisfying the power-saving condition before completing the pending queued tasks. In one embodiment, the power-saving condition is satisfied when the storage device stores the pending queued tasks into a non-volatile memory. In another embodiment, the power-saving condition is satisfied when the storage device notifies the host controller to reschedule the pending queued tasks after waking up from the power-saving mode. For example, each pending queued task can be notified via corresponding task information comprising a task identification (ID), a task size, an address associated with task data, and a task status.

FIG. 7 is a flow chart of a method of power saving, from host controller perspective, for storage device with device queue management in accordance with embodiments of the current invention. In step 701, a host controller sends a plurality of task requests to a storage device. Each task request is pushed into a task queue of the storage device for later execution. In step 702, the host controller transmits a power-saving command to the storage device for the storage device to enter a power saving mode while there are pending queued tasks remained in the task queue of the storage device. In step 703, the host controller receives task information for the pending queued tasks from the storage device. For example, each pending queued task can be notified via corresponding task information comprising a task ID, a task size, an address associated with task data, and a task status. In step 704, the host controller reschedules the pending queued tasks after waking up the storage device.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
accepting a plurality of task requests from a host controller by a storage device, wherein each task request is pushed into a task queue of the storage device for later execution;
receiving a power-saving command from the host controller for the storage device to enter a power-saving mode while there are pending queued tasks remained in the task queue of the storage device;
processing the pending queued tasks to satisfy a power-saving condition; and
entering the power-saving mode upon satisfying the power-saving condition before completing the pending queued tasks.

2. The method of claim 1, wherein the storage device communicates with the host controller via a command bus for exchanging commands and a data bus for reading and writing data.

3. The method of claim 1, wherein the power-saving condition is satisfied when the storage device stores the pending queued tasks into a non-volatile memory.

4. The method of claim 3, wherein the storage device pushes the pending queued tasks into the task queue after waking up from the power-saving mode.

5. The method of claim 1, wherein the power-saving condition is satisfied when the storage device notifies the host controller to reschedule the pending queued tasks after waking up from the power-saving mode.

6. The method of claim 5, wherein the storage device clears the pending queued tasks in the task queue after notifying the host controller.

7. The method of claim 5, wherein each pending queued task is notified via corresponding task information comprising a task ID, a task size, an address associated with task data, and a task status.

8. A storage device, comprising:
a task queue that accepts a plurality of task requests from a host controller, wherein each task request is pushed into the task queue of the storage device for later execution;
a command bus that receives a power-saving command from the host controller for the storage device to enter a power-saving mode while there are pending queued tasks remained in the task queue of the storage device; and
a processor that processes the pending queued tasks to satisfy a power-saving condition, wherein the storage device enters the power-saving mode upon satisfying the power-saving condition before completing the pending queued tasks.

9. The storage device of claim 8, wherein the storage device communicates with the host controller via the command bus for exchanging commands and a data bus for reading and writing data.

10. The storage device of claim 8, wherein the power-saving condition is satisfied when the storage device stores the pending queued tasks into a non-volatile memory.

11. The storage device of claim 10, wherein the storage device restores the pending queued tasks into the task queue after waking up from the power-saving mode.

12. The storage device of claim 8, wherein the power-saving condition is satisfied when the storage device notifies the host controller to reschedule the pending queued tasks after waking up from the power-saving mode.

13. The storage device of claim 12, wherein the storage device clears the pending queued tasks in the task queue after notifying the host controller.

14. The storage device of claim 12, wherein each pending queued task is notified via corresponding task information comprising a task ID, a task size, an address associated with task data, and a task status.

15. A method, comprising:
sending a plurality of task requests from a host controller to a storage device, wherein each task request is pushed into a task queue on the storage device for later execution;
transmitting a power-saving command to the storage device for the storage device to enter a power-saving mode while there are pending queued tasks remained in the task queue of the storage device;
receiving task information for the pending queued tasks from the storage device; and
rescheduling the pending queued tasks after waking up the storage device.

16. The method of claim 15, wherein the host controller communicates with the storage device via a command bus for exchanging commands and a data bus for reading and writing data.

17. The method of claim 16, wherein the host controller further communicates with the storage device via a signal bus for clock and power supply.

18. The method of claim 15, wherein the task information comprises a task ID, a task size, an address for task data, and a task status for each pending queued task.

19. The method of claim 15, wherein the host controller turns off a supply power to the storage device upon the storage device enters the power-saving mode.

20. The method of claim 15, wherein the host controller transmits the power-saving command before checking whether the task queue of the storage device is empty such that the storage device enters power-saving mode before completing the pending queued tasks.
